(19) United States
(12) Patent Application Publication
(10) Pub. No.: US 2018/0023269 A1
(43) Pub. Date: Jan. 25, 2018

(54) HYDRAULIC DEVICE

(71) Applicant: 380 INVENT APS, Nr. Aaby (DK)

(72) Inventors: Daniel DUUS, Middelfart (DK); Maria GADE, Middelfart (DK)

(21) Appl. No.: 15/551,764

(22) PCT Filed: Feb. 18, 2016
(86) PCT No.: PCT/DK2016/050047

§ 371 Date: Aug. 17, 2017

(30) Foreign Application Priority Data
Feb. 19, 2015 (DK) PA 2015 00098

(51) Int. Cl. E02F 3/36; F15B 15/06

(52) U.S. Cl. CPC E02F 3/3663; E02F 3/3618; E02F 3/3681; F15B 15/061

(57) ABSTRACT

The invention concerns a hydraulically constructed device for mounting between an earthmoving machine and a tool. The device is secured to the earthmoving machine and connected to the earthmoving machine's hydraulic system. The operator can from the panel in the driver's cabin of the earthmoving machine control the device to place the tool in motion. For this, the device can be outfitted with a quick change unit. This hydraulic device functions with or without a quick change unit. The device is built around a housing (10) consisting of at least one main axle (4) and a slide (6). The slide is movable in that the main axles are led through the slide, and furthermore on the outside of the slide there are a number of spiral slots (20) with a conformation corresponding to a number of loose keys (9). The loose keys are fixed in such a way that they create the connection between the housing and the spiral slots. The loose keys are configured such that they are adapted to the slots in the slide and can move in them, and advantageously they remain a replaceable wearing part.

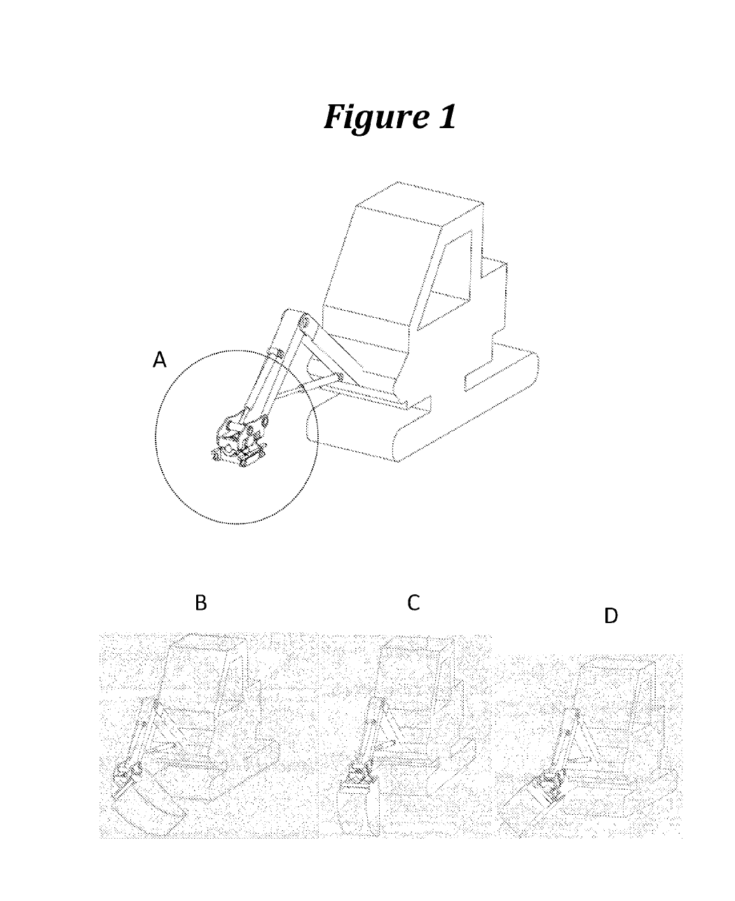

The invention concerns a hydraulically constructed device with possibility of adding a quick change unit, for mounting between an earthmoving machine and a tool, such as an excavating implement like a shovel (see FIG. 1 for an illustration of how the device goes into an earthmoving machine) and which when mounted between an earthmoving machine and a tool can set a tool in motion. The device is of the kind which is built around a housing, which transforms forces into rotation of a tool mounted on such a device. The device is secured to the earthmoving machine and connected to the earthmoving machine's hydraulic system. The operator from the panel in the driver's cabin of the earthmoving machine can control the device to drive the tool in motion, rotate it, or place it in a desired position. In this the operator achieves much greater flexibility and ability to adapt the mounted excavating implement to the specific excavating purpose than the earthmoving machine is outfitted with from the beginning. When the operator from the driver's cabin activates the device, the hydraulic oil is forced from the earthmoving machine's hydraulic system into the forechamber or rear chamber of the device, depending on which direction or movement the device and thus the tool is supposed to attain in order to perform excavating work, for example. For this, the device can be outfitted with a quick change unit. The quick change unit is connected to the earthmoving machine's hydraulic system. The quick change unit contributes the ability to undertake a changing of excavating implement from the driver's control panel and thereby switch between various mounted excavating implements without the operator having to leave the driver's cabin. Without a quick change unit this operation will be done manually. This hydraulic device functions with or without a quick change unit.

The known devices of this kind are characterized in that they transform forces in a housing which are passed on to the device, where the forces create the motion in the mounted tool, which means that the tool can be tilted, rotated, placed in motion by the operator from the driver's control panel when it is connected to the earthmoving machine's hydraulic system.

It is known from patent U.S. Pat. No. 5,242,258 that the housing is constructed with spiral splines and constructed with spiral splines on the inside and outside of the piston, and there are likewise spiral splines on the outside of the main axle. The spiral splines serve the purpose of transferring the force as the piston moves back and forth from the housing via the spiral splines on the outside of the piston to the spiral splines on the inside of the piston, thereby causing the main axle to rotate. In this type of device, it is the cut splines which convert the forces from movement to rotation. The cut splines are limited in size, since it is difficult to create large splines in the fabrication process. At the same time, the cut splines are subjected to a greater degree of wear. Furthermore, the splines are a fixed part of the construction. This means that already at relative slight wear, the ability to absorb the forces transmitted from the earthmoving machine is substantially decreased, so that the load rating of the splines is reduced with wear. Furthermore, the splines are not a replaceable wearing part, which means that this type of device is costly to maintain and has a short lifetime.

From patent US20100095720 A1 it is known that the main axle is constructed like a two-sided displacement cylinder. At the middle of the main axle there is mounted a cylindrical slide rail which secures the bottom of the device to the main axle. At the other side of the main axle is mounted a slide with spiral shaped track. The angled track has contact with the fixed part of the device, on which there is likewise a spiral shaped track. This means that when the main axle is moved back and forth by the hydraulic oil, the force from the cylindrical slide rail is taken via the main axle to the slide rail with the angled track, which acts on the fixed part of the device and the device seesaws. This type of design of the device is vulnerable to extreme loads, so that one part of its design is that a double hydraulic brake is mounted on the device which locks the device when it is not in use.

The issue with this type of device is that all forces are transmitted via a main axle which has a cross bore, and thus is not very robust to the large stresses to which it is subjected from the earthmoving machine. Meanwhile, there has been an attempt to remedy this problem by using hydraulic brakes in the ends of the device, here, both ends. But this design makes the product needlessly complex, which increases the number of wearing parts while at the same time subjecting the structure to needless stress. These are elements in the structure which shorten the lifetime of the devices and make them hard to work with.

From patent US2011/0154920A1 it is known that the housing construction has one cylindrical half part and the other half part is elliptical. The cylindrical part of the housing is used as a bearing housing for the rotation and the elliptical part of the housing is used as a cylindrical wall for the main piston. The piston is configured as an ellipse. The elliptical part of the housing constitutes the cylindrical part of the device.

Since the cylinder head is elliptical, it is able to transfer the forces from the device's fixed part via the spiral splines on the device's main axle. In this type of device, all forces are transmitted via the elliptical housing to an elliptical piston. Which means, in this design, that there are enormous forces on the housing's wall. This loading means that the cylinder housing and the cylinder walls are subjected to a somewhat greater degree of wear than other devices. The needless stresses increase the number of wearing parts and give the device a short lifetime.

From patent KR20020065878A/Aug. 14, 2002 it is known that the forces in the housing are converted by rollers to certain spiral tracks. Because all forces are converted by rollers, there is a very slight contact surface between roller and slide, which limits the strength of the forces which the device can sustain. Furthermore, one drawback of this design is that, when subjected to rather high loading, the rollers become deformed and marks are left behind in the passageways which make the device defective, so that this design is very fragile and not suitable to being mounted on an earthmoving machine.

It is a clear drawback that the known designs are characterized either in having many wearing parts as a fixed part of the design and which cannot be replaced, which shortens the quality and lifetime of the device, makes it vulnerable to wear, and quickly lowers the load rating of the device, and/or having a complicated design which cannot optimally utilize the forces, and/or which creates a needless stress on wearing parts, or creates a relatively awkward and large and vulnerable product with low flexibility that makes maintenance and possible applications more difficult, in terms of weight, ability to make optimal use of the forces, number of wearing parts and installation height.

The invention provides a device of the kind mentioned in the introduction, where the design of the invention ensures that the load bearing ability is not diminished during use and/or by wear, which is the case with similar existing devices. The invention accomplishes a lower installation height, the wearing parts are replaceable, and a substantially more simple design, which also consists of fewer parts and which achieves a significantly lower total weight, which also makes it easier to handle in a situation of use. Furthermore, the design of the invention strengthens the device in that the forces to which it is exposed have a sole purpose and parts are not exposed needlessly to forces or loads when this provides no utility, and also the invention ensures that the forces do not needlessly damage wearing parts, which directly affects the device's lifetime.

This is accomplished according to the invention in a device of the kind mentioned at the outset and characterized in that the device is composed of a slide which consists of external keyways in which loose keys are in movement and wherein the housing is constructed with more than one axle which is placed through the slide and wherein the slide is movable as a result of at least one key/slot connection between at least one main axle and slide.

This directly contributes to a device which, besides the aforesaid qualities, is much more flexible and user-friendly as compared to existing devices.

The invention is mounted on the earthmoving machine and connected to its hydraulic system. The fixed part of the device is mounted on the earthmoving machine. The main axles are secured to the fixed part. The main axles are placed through the slide, and because there is more than one axle doing the steering, the main axles lock the slide so that it does not start to rotate. On the slide's outside there are spiral keyways, and in these keyways slide replaceable loose keys or similar loose guides. The loose keys are fixed in the device's housing with fitting bolts. The hydraulic hoses are mounted on the device in the device's main bearings. When the hydraulic oil is taken to the front end or rear end of the slide, the slide is forced in forward or backward motion, respectively. Since the slide is guided on the main axles and the loose keys are guided to the housing, the device gradually rotates to the left or right, respectively, determined by the operator from the earthmoving machine's control panel.

With external spiral keyways and loose keys one achieves a higher and stronger key and slot connection which provides a stronger structure and a wear-resistant product as compared to existing devices of similar kind, which are characterized in that they have cut splines. What is more, with this design of keys and slots one achieves a unique greater height, which means it is not exposed to the same degree of reduction in ability to take up the forces in tandem with wear, as compared to existing solutions with conical splines, for example. Furthermore, a unique feature of the design is that it consists of more than one main axle. With the use of several main axles, the device achieves the unique property that the main axles have the function of both binding the structure together and taking up rotation forces. It is uniquely different from earlier designs and this invention eliminates awkward, complicated and/or heavy designs. For example, this design eliminates the need for a keyway or spline assembly. What is more, this design with the main axles form and placement achieves a full engagement, the load rating is constant and not affected by the placement of the slide, and the main axles lock the slide in such a way that it can only move forward and back. The invention of this combination achieves an overall unique product with a design which is significantly more simple, robust, consisting of fewer wearing parts and having replaceable wearing parts, with a low installation height, and not passing on any needless force actions.

The invention concerns a hydraulic device for mounting between an earthmoving machine and a tool, where the main axles are surrounded by a housing and where the housing contains more than one main axle. The housing and the main axles rotate about the same center lines, wherein on the main axles, at either side of the housing, there is an end flange and a fixation device consisting of, for example, a clamping plate, and which is part of the device's fixed part, while the end flange is part of the device's movable part. The clamping plate is fastened to the fixed part by main bearings and the main axles run through the main bearings and are fastened to the device's fixed part. Furthermore, the device comprises a slide between the main axles' outer diameter and the housing's inner diameter, wherein the slide is axially movable as a result of a coupling to an axle which is placed off-center or several axles which are placed axially through the slide, and wherein furthermore on the outside of the slide there are a plurality of spiral slots with a conformation corresponding to a plurality of loose keys, wherein the loose keys with the help of a plurality of fitting bolts, lock pins, bolts, or welding together are connected to the housing and wherein there are hydraulic channels and hydraulic supply and drain lines in the main axles or in the housing.

The spiral slots on the outside of the slide have a conformation in both extent and cross section that corresponds to at least one loose key. The loose keys can have the configuration of a cylinder, a sphere, or a plurality of rounded or curved edges/surfaces. And the loose key or keys have a top side, a bottom side, and at least four edges/surfaces, where the top side and the bottom side are curved and where at least two of the sides are perpendicular to the curved top side and the curved bottom side and have a plurality of holes in the top side along the center line of the loose key or keys. Furthermore, the loose keys can be replaceable.

Moreover, the hydraulic device can optionally comprise a quick change unit.

The invention shall be explained more closely below, making reference to the drawings, where

FIG. 1 shows how the device is placed on an earthmoving machine and its mode of operation. Feature A shows a device mounted on an earthmoving machine without tool. Feature C shows an earthmoving machine where the device is mounted along with tool mounted in the starting position. Feature B and feature D show the device in operation, where the device has brought the excavating implement into a gradual position at the right and left, respectively.

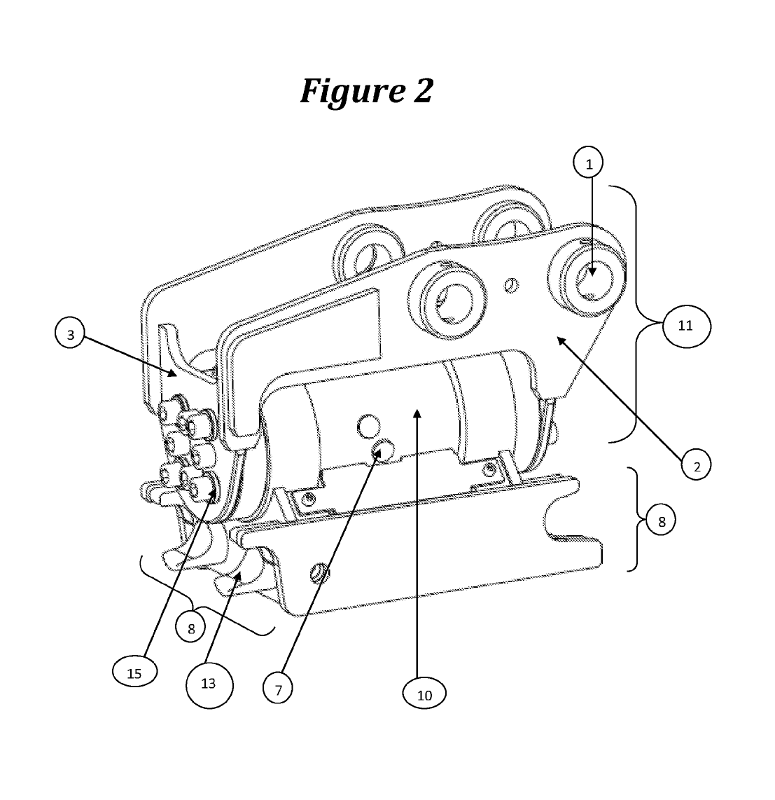

FIG. 2 shows the device seen as a whole.

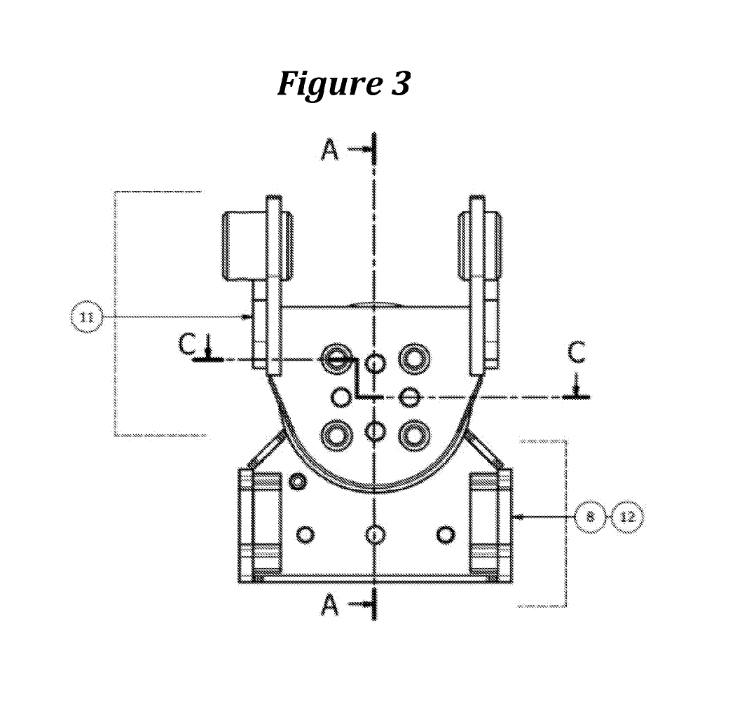

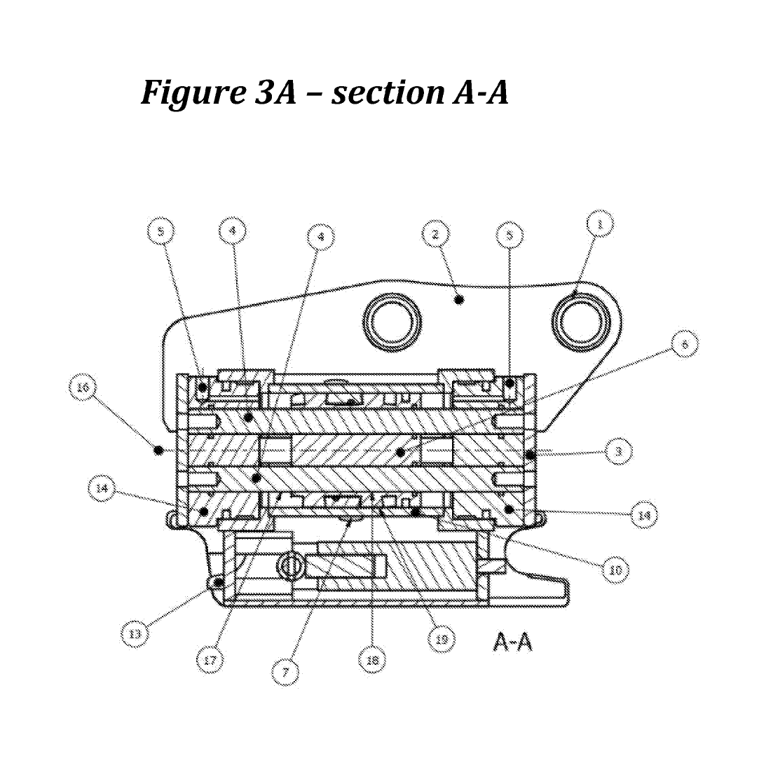

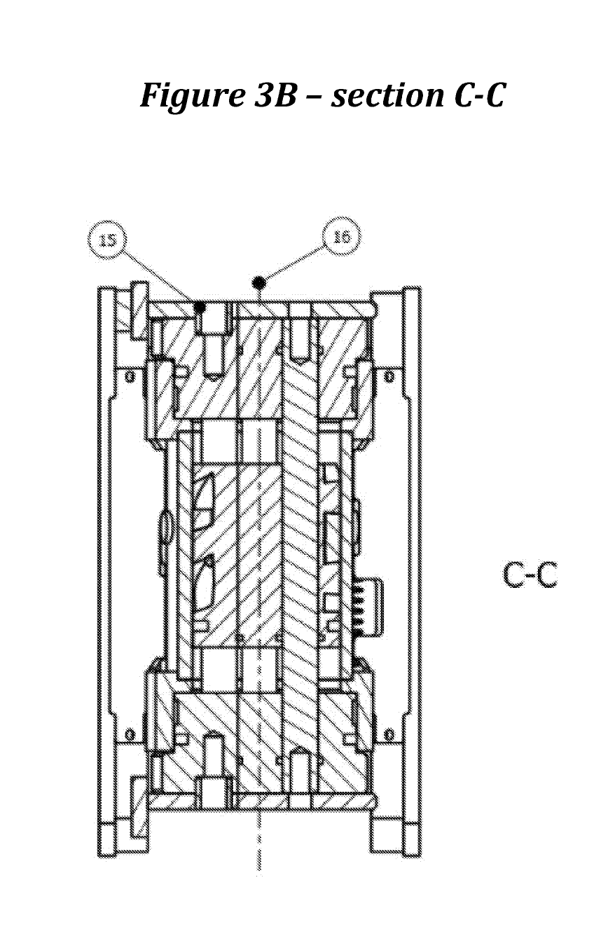

FIG. 3 is an overview, from which sections are taken for a sectional representation of the device in isometric view. FIG. 3A shows a sectional view of the device seen from A-A and FIG. 3B shows a sectional view of the device seen from C-C.

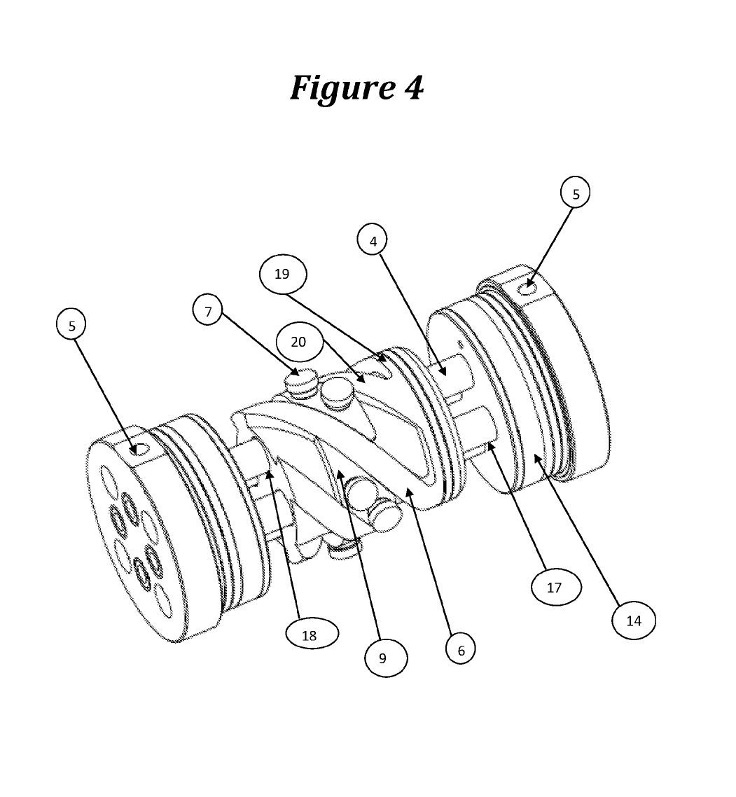

FIG. 4 shows the slide as a self-standing unit mounted with loose keys.

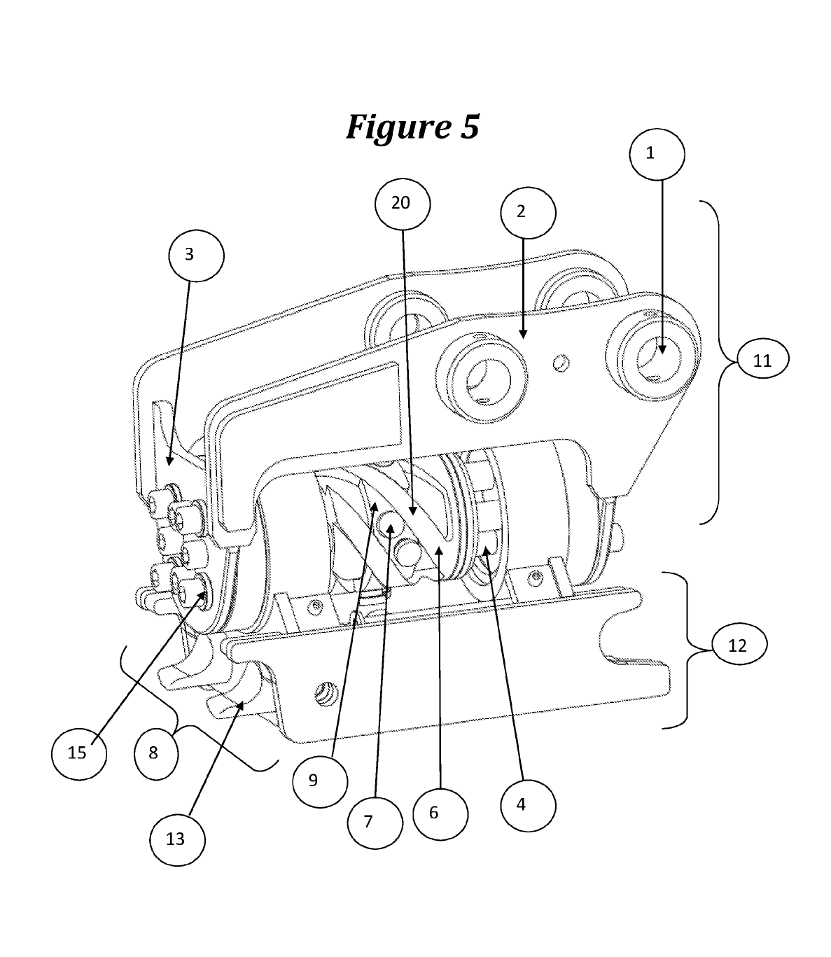

FIG. 5 shows the device without housing.

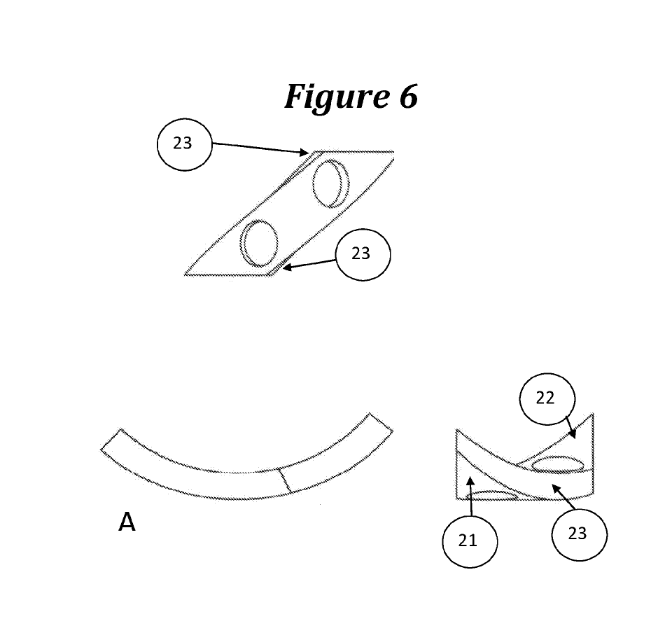

FIG. 6 shows an example of how the loose keys can be configured. Besides the example shown, the loose keys can also have, for example, cylindrical, curved or round shapes, or be configured as spheres.

The following is a list of designations of the elements of the device, whose numbering is used in the aforementioned figures.
1.: Bushings
2.: Beam
3.: Clamping plate
4.: Main axles
5.: Hydraulic supply and drain lines
6.: Slide
7.: Fitting bolts
8.: Quick change unit
9.: Loose keys
10.: Housing
11.: Fixed part of device
12.: Movable part of device
13.: Locking keys
14.: Main bearings
15.: Guide bushings
16.: Center lines
17.: Main axle's outer diameter
18.: Housing's inner diameter
19.: Bottom of the slide
20.: Spiral slot
21.: Loose key top side
22.: Loose key bottom side
23.: Loose key sides/edges/surfaces

The device is outfitted with bushings (1) for bolts used in the mounting on the earthmoving machine's arm. The device's fixed part (11) consists of beams (2).

Between the device's beams (2) is fastened the clamping plate (3). On the clamping plate (3), both the main axles (4) and the main bearings (14) are fastened. The clamping plate (3) is controlled together with the main bearings (14) by means of the guide bushings (15). This constitutes the fixed part (11).

The device is constructed around a housing (10) through which the main axles (4) run. The main axles create the connection between the slide (6) and the fixed part of the device (11), and through which are conducted the forces from the fixed part to the movable part (12). Hydraulic supply lines (5) are led through the main bearings (14).

Through the main axles (4), the forces are conducted to the slide (6). The slide functions like a piston head, which also has the function of conducting the forces from the main axles (4) to the loose keys (9). The loose keys (9) are fixed with fitting bolts (7). The fitting bolts are mounted in the housing (10) and create the connection between the housing and the loose keys (9). The loose keys are configured so as to adapt to the passageways in the slide (6) and can move therein, whether round, spherical, curved, spiral or the like. Moreover, the loose keys are configured and mounted so that they become a replaceable wearing part. The device has a quick change unit (8) which is secured to the device's movable part (12). The quick change unit consists of a hydraulic piston which is connected to the earthmoving machine's hydraulic system, and which thereby presses forward a plurality of locking keys (13) and can fix the excavating implement to the quick change unit. In this way, the operator can switch between excavating implements from the earthmoving machine's control panel.

1. Hydraulic device for mounting between an earthmoving machine and a tool, comprising one the main axle which is surrounded by a housing, where the housing and main axle have center lines which coincide, where the main axle is longer than the housing and where there are main bearings, guide bushings and a clamping plate on the main axle, on either side of the housing, being parts of the device's fixed part, while fitting bolts, loose keys, the housing and locking keys constitute parts of the device's movable part, and where the device furthermore comprises a slide between the housing's inner diameter and the main axle's outer diameter and the housing's inner diameter, where the slide is axially movable due to the fact that the slide is led through a main axle and where the main axle is parallel to the housing's center lines, and where furthermore there is a plurality of spiral slots on the outside of the slide with a conformation corresponding to a plurality of loose keys, where the loose keys are connected by a plurality of fitting bolts to the housing and where there are hydraulic channels to hydraulic supply and drain lines in the main bearings.

2. Hydraulic device according to claim 1, wherein the device comprises at least one additional main axle.

3. Hydraulic device according to claim 1, wherein the spiral slots on the outside of the slide have a conformation in both extent and cross section corresponding to at least one loose key and the at least one loose key is secured to the housing, while the at least one slot is placed on the outside of the slide.

4. Hydraulic device according to claim 1, wherein the at least one loose key is cylindrical, spherical, or has a plurality of rounded or curved edges/surfaces.

5. Hydraulic device according to claim 1, wherein the at least one loose key has a top side, a bottom side and at least four sides/edges/surfaces, where the top side and the bottom side are curved and where at least two of the sides are perpendicular to the curved top side and the curved bottom side.

6. Hydraulic device according to claim 1, wherein at least one loose key has a plurality of holes in the top side along the center line of the at least one loose key.

7. Hydraulic device according to claim 1, wherein the at least one loose key is replaceable.

8. Hydraulic device according to claim 1, wherein the device can furthermore comprise at the movable part a quick change unit, designed for fixation of a tool, wherein the quick change unit is connected to at least two locking keys.

9. Hydraulic device according to claim 1, wherein the at least two locking keys are connected to hydraulic supply and drain lines.

10. Hydraulic device according to claim 1, wherein it is used for mounting between an earthmoving machine and a tool, such as a shovel.
